(19) United States
(12) Patent Application Publication
(10) Pub. No.: US 2013/0234496 A1
(43) Pub. Date: Sep. 12, 2013

(54) Planter dual wheel mounting device

(71) Applicant: Shawn Gengerke, Groton, SD (US)

(72) Inventor: Shawn Gengerke, Groton, SD (US)

(21) Appl. No.: 13/385,863

(22) Filed: Mar. 12, 2012

(51) Int. Cl. B60B 11/00

(52) U.S. Cl. 301/35.628

(57) ABSTRACT

A device for mounting an additional wheel on an agricultural planter to provide a dual wheel assembly. Said device comprising a generally cylindrical member with radially projecting flanged portions at each end thereof, a plurality of apertures extending through the flanged portion at one end of said cylindrical member and positioned to receive the wheel mounting studs of a planter's wheel hub, and a plurality of externally threaded shafts projecting outwardly from the flanged portion at the opposite end of said cylindrical member and positioned to mate with the mounting apertures of the auxiliary planter wheel being added.

### BACKGROUND OF THE INVENTION

1. Field of the Invention

The present invention relates to a hub extension for attaching dual wheels to an agricultural planter and in particular to a hub extension for use on Bauer-John Deere and Case IH planters.

2. Description of the Related Art

A planter is an agricultural farm implement towed behind a tractor, used for sowing crops through a field. The planter is connected to the tractor with a draw-bar, or a three-point hitch. Planters lay the seed down in precise manner along rows. Seeds are distributed through devices called row units. The row units are spaced evenly along the planter. Planters vary greatly in size, from 2 rows to 48, with the largest being the 48-row John Deere DB120. Prior art planters typically included one or more axles containing a single wheel at each end of the axle. When using the prior art planters, the single wheels commonly cause excessive soil compaction, lack traction during wet conditions and cause significant stress on the planter.

### SUMMARY OF THE INVENTION

The present invention comprises an auxiliary wheel adapter system with the mounting of an auxiliary wheel in coaxial alignment with the existing wheel and at a disposition closely spaced laterally of the existing planter wheel. The dual wheels of the present invention overcome the shortcomings of the prior art by improving the planter's traction and reducing soil compaction by decreasing the weight carried by each tire.

The present invention utilizes a substantially simple adaptor device, which includes a reinforced tubular frame, inboard and outboard external flange structures arranged respectively on opposite ends of the tubular frame. The coaxial mounting of the auxiliary wheel permits the wheel to readily be mounted adjacent to an existing planter wheel without modification to the planter's axle or structure. Also, the auxiliary wheel means of the invention may be formed to a diameter smaller than the diameter of the existing planter wheel and thus permit the auxiliary wheel to engage the supporting surface only at such times as when the planter is traversing soft or muddy terrain.

The auxiliary wheel also provides a greater width and, therefore, greater stability to the planter. The adaptor device of the present invention utilizes existing wheel fastening means in fastening the auxiliary wheel on the existing wheel structure of the planter and may readily be installed or removed from the existing wheel structure of the planter. The substantially simple and durable structure of the adapter device of the invention provides adaptor means which is strong and durable and an adapter device which may readily be economically fabricated and marketed.

These, and other, aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a side perspective view of the adapter device in accordance with the preferred embodiments of the present invention.

FIG. 2 is a side perspective view of the adapter device illustrating the inboard and outboard flanges in accordance with the preferred embodiments of the present invention.

FIG. 3 is a front perspective view of the inboard flange in accordance with the preferred embodiments of the present invention.

FIG. 4 is a side perspective view of the adapter device in accordance with the preferred embodiments of the present invention.

FIG. 5 is a side perspective view of the tubular frame, inboard flange, outboard flange and threaded shafts of the adapter device in accordance with the preferred embodiments of the present invention.

FIG. 6 is a front perspective view of an agricultural planter with dual wheels in accordance with the preferred embodiments of the present invention.

### DESCRIPTION OF THE PREFERRED EMBODIMENT

The present invention and the various features and advantageous details thereof are explained more fully with reference to the non-limiting embodiments described in the following description.

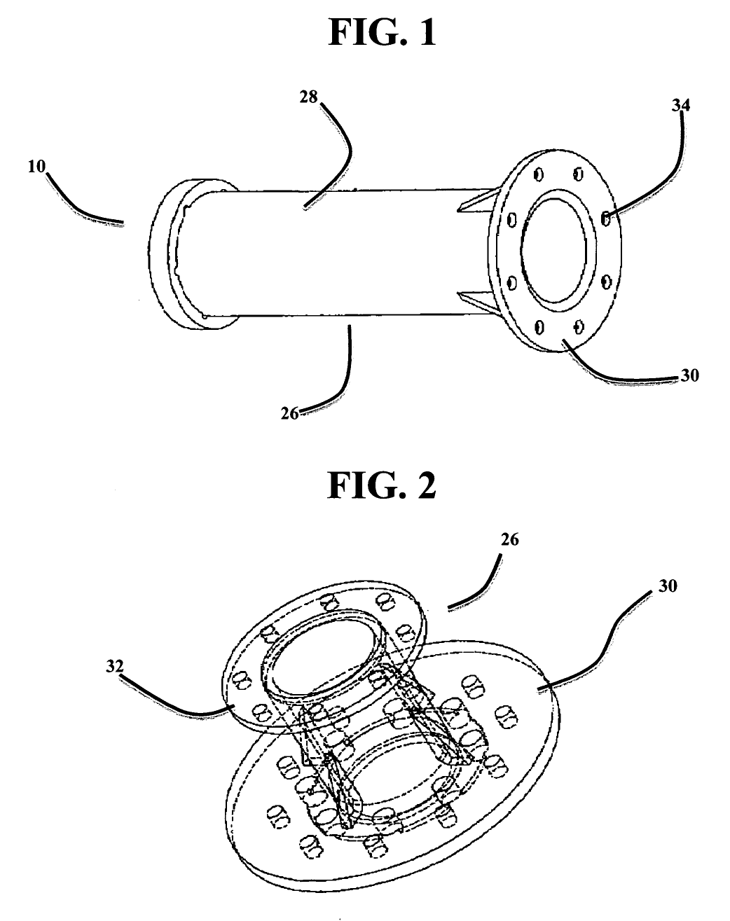

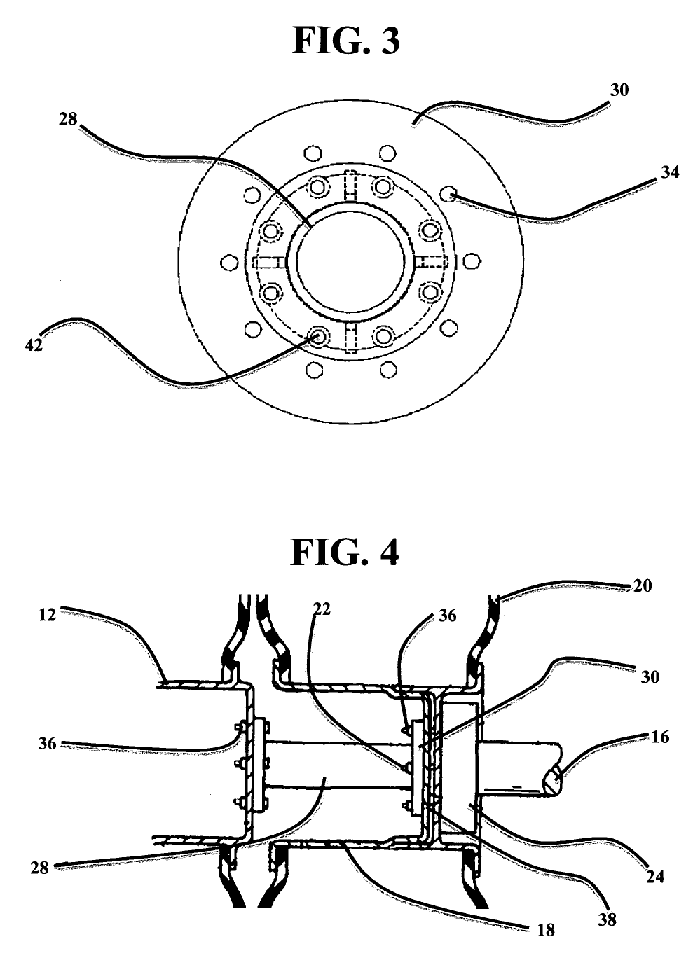

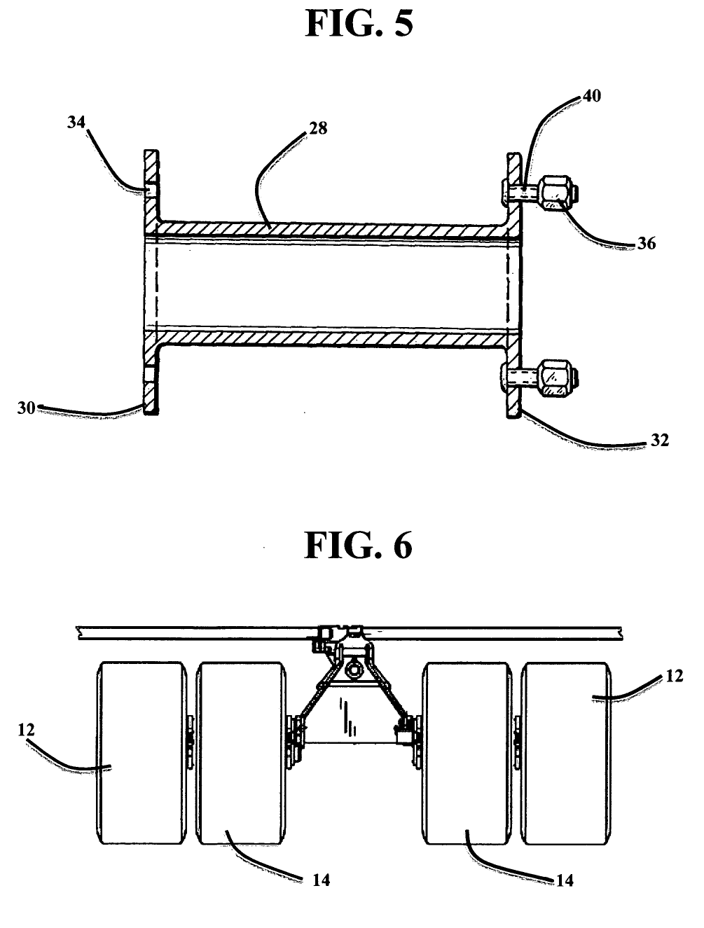

FIGS. 1 through 6 show a device of the present invention which allows for attaching dual wheels to an agricultural planter. The adaptor means of the present invention is indicated by numeral 10 and will be described in conjunction with the auxiliary planter wheels 12 and the OEM planter wheels 14 supported on the planter axles 16. The OEM planter wheels 14 include inboard steel rim structures 18 concentrically fitted respectively with surface engaging tire structures 20. A plurality of bolt apertures 38 arranged in a circular pattern (not shown) to match the pattern of the wheel mounting studs 22. The mounting studs 22 are inserted through the bolt apertures 38 of the OEM rim structure 18. Wheel nuts 36 are threaded onto the mounting studs 22 to secure the OEM planter wheel 14 to the planter hub 24.

Auxiliary wheel adaptor means 10 includes an adaptor device 26 adapted to coactingly engage existing OEM wheel 14 and wheel fastening means 22 of the planter. Adaptor device 26 consists of a tubular frame 28; inboard and outboard external flange structures 30, 32 arranged respectively on opposite end portions of the tubular frame 28. The tubular frame 28 can be of varying lengths depending upon the planter model.

Adaptor device 26 is adapted to be fitted substantially within the interior of steel rim 18 of OEM tire wheel 14. The inboard flange structure 30 of adaptor device 26 has a plurality of bolt apertures 34 arranged in a circular pattern having the same diameter as, and aligned with the apertures 38 in the OEM rim 18. The wheel nuts 36 are removed from the mounting studs 22. The mounting studs 22 are then inserted through the bolt apertures 34 of the adapter device 26. Thereafter, wheel nuts 36 are threaded onto the studs 22, in a conventional manner, and are tightened to secure the OEM wheel 14 and the adapter device 26 to the planter hub 24. It will be understood that the number of bolt apertures 34 provided on the inboard flange 30 and the spacing thereof will be determined by the number and spacing of the wheel mounting studs 22 of the planter hub 24.

At the opposite end of the tubular frame 28, the outboard flange 32 is provided with a circular pattern of apertures 42. Maintained within the apertures 42 are a plurality of externally threaded shafts 40 which project outwardly from the outboard flange 32 substantially parallel to the axis of the tubular frame 28 and spaced equally thereabout to mate with the mounting apertures 44 of the auxiliary wheel 12. Obviously, the number and spacing of the threaded shafts 40 will be determined by the number and spacing of the mounting apertures 44 of the auxiliary wheel 12. The threaded shafts 40 are inserted through the mounting apertures 44 of the auxiliary wheel 12. Wheel nuts 36 are threaded onto the threaded shafts 40 to secure the auxiliary wheel 12 to the adapter device 26.

To mount dual wheels on the planter hub 24, using the adapter device 26, the OEM wheel 14 is mounted inserting the wheel mounting studs 22 of the planter hub 24 through the mounting apertures 38 of the OEM wheel 14, in a conventional manner. Next, the wheel mounting studs 22 of the planter hub 24 are inserted through the apertures 34 of the inboard flange 30 of the adapter device 26. Thereafter, wheel nuts 36 are threaded onto the wheel mounting studs 22, in a conventional manner, and are tightened to secure the OEM wheel 14 and adapter device 26 to the planter hub 24. Next, the auxiliary wheel 12 is mounted by inserting the shafts 40 of the outboard flange 32 of the adapter device 26 through the mounting apertures 42 of the auxiliary planter wheel 12. Thereafter, wheel nuts 36 are threaded onto the shafts 40 and tightened to secure the auxiliary planter wheel 12 to the outboard flange 32.

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept. It is intended that the appended claims cover all such additions, modifications and rearrangements.

### Index of Elements for Planter Dual Wheel Mounting Device

10. Adapter Means
12. Auxiliary Planter Wheel
14. OEM Planter Wheel
16. Planter Axle
18. OEM Rim
20. OEM Tire
22. Wheel Mounting Studs
24. Rotating Hub
26. Adapter Device
28. Tubular Frame
30. Inboard Flange
32. Outboard Flange
34. Inboard Flange Apertures
36. Nuts
38. OEM Rim Bolt Apertures
40. Externally Threaded Shafts
42. Outboard Flange Apertures
44. Auxiliary Wheel Apertures

1. A device for converting at least one wheel of a planter from single wheel support to dual wheel support, said device comprising:
a cylindrical member formed with radially directed flange means at each end of the cylinder member;
a plurality of apertures extending through the flange means at one end of the cylindrical member, the apertures being sized, shaped and arranged so as to be adapted to receive wheel mounting studs of a planter's wheel hub comprising an original planter's single wheel support such that said flange means at the one end of the cylindrical member becomes interposed between the hub and a set of lug nuts when secured to said wheel mounting studs;
a plurality of externally threaded shafts projecting parallel to the axis of the cylindrical member outwardly from the radially directed flange means at the end of the cylindrical member opposite said one end, the shafts being equally radially and circumferentially spaced from the axis of the cylindrical member so as to be adapted to match a hole pattern on an auxiliary planter wheel.

2. A device for mounting a dual wheel on a planter, said device comprising:
a cylindrical member formed with flanged portions at each end thereof;
a plurality of apertures extending through the flanged portion at one end of said cylindrical member and positioned so as to be adapted to receive wheel mounting studs of a planter wheel hub; and
a plurality of externally threaded shafts projecting outwardly from the flanged portion at the end of the cylindrical member opposite said one end, said threaded shafts extending parallel to an axis of said cylindrical member and positioned so as to be adapted to mate with mounting apertures of an auxiliary planter wheel.
